(19) United States
(12) Patent Application Publication
(10) Pub. No.: US 2022/0033083 A1
(43) Pub. Date: Feb. 3, 2022

(54) PASSENGER SEAT UNIT FOR AN AIRCRAFT CABIN

(71) Applicant: Style & Design Group, Maurepas (FR)

(72) Inventors: Romain Chareyre, Clamart (FR); Laurent Stritter, Elancourt (FR); Pierrick Henri, Paris (FR); Charles Ehrmann, Les Breviaires (FR)

(73) Assignee: Style & Design Group, Maurepas (FR)

(21) Appl. No.: 17/290,398

(22) PCT Filed: Oct. 31, 2019
(86) PCT No.: PCT/EP2019/079938

§ 371 Date: Oct. 19, 2021

Related U.S. Application Data
(60) Provisional application No. 62/755,028, filed on Nov. 2, 2018.

(51) Int. Cl. B64D 11/06

(52) U.S. Cl. CPC B64D 11/0641; B64D 11/0643; B64D 11/0642; B64D 11/0601; B64D 11/0638; B64D 11/0606; B64D 11/0605

(57) ABSTRACT

The invention describes a passenger seat unit for an aircraft cabin, comprising a seat surface (10), a backrest (20) and a leg rest (30), and having:
an upright configuration in which the backrest (20) and the leg rest (30) are in a first position, and
a bed configuration in which the backrest (20) and the leg rest (30) are in a second position, the backrest (20), the seat surface (10) and the leg rest (30) forming a substantially plane and continuous surface,
   characterised in that:
the seat surface (10) is fixed,
the backrest (20) is mounted mobile in rotation around a joint axis between the backrest and the seat surface (29),
the leg rest (30) is mounted mobile in rotation around a joint axis between the leg rest and the seat surface (39).

### FIELD OF THE INVENTION

The present invention relates to the field of passenger seats for aircraft cabins.

### PRIOR ART

Commercial airline flights are becoming longer. In fact, the range of long-haul aircraft tends to increase with new-generation aircraft, and flight speed is tending to drop to optimise fuel consumption. In this way, at present flights can last up to 19 hours. Offering passengers adequate comfort is all the more necessary because flights are long.

Also, passengers are demanding more and more comfort during flights, in particular premium passengers in business class or first class. Comfort criteria are likely to vary from one passenger to the other as a function of age, gender, size, possible illnesses, etc.

One comfort criterion commonly recognised by passengers is the possibility of benefiting during the flight from an active and non-passive seat surface, that is, being able to shift from one position to another on their seat. An active seat surface promotes movement, improves posture, activates the muscles of the body and varies those areas of the body which are in contact with the seat.

Some modern aircraft are equipped with passenger seats mobile between a seat surface position and a passenger reclining position, so as to adapt to the needs of the passenger during flight.

The seat is in seat surface position during take-off and landing for example, or again when the passenger is having meals, and can be activated into the reclining position during cruising, for example when the passenger wants to rest or sleep.

A passenger seat such as those currently fitted in some airliners is illustrated by way of example in FIGS. 1a, 1b and 1c. The seat comprises a backrest 20′, a seat surface 10′ and a leg rest 30′. The seat is inclinable between a seat surface position, shown in FIG. 1a, one or more intermediate positions, such as the position shown in FIG. 1b, and a reclining position, shown in FIG. 1c. The seat is inclinable between the different positions by way of deployment kinematics using electrical actuators. In general, the seat comprises two to four actuators and kinematics sliding around 500 mm towards the front to shift the seat into the reclining position. The actuation kinematics of the seat also imply the installing of longitudinal rails and electronic boxes under the seat. Given the constraints on dimension of an aircraft seat, the seat surface 10′ of the seat pivots and/or slides on a seat surface support to engender movement of the entire seat. The passenger controls movement of the seat between the seat surface and supine positions by way of buttons to actuate the mechanics of the seat, which are integrated into an armrest of the seat for example. The kinematics for actuating the seat must further be dimensioned so as to accommodate a passenger weighing 120 kg in all movements which are accessible to him, with a large cantilever bed.

The kinematics for actuating the seat described hereinabove therefore considerably increase the complexity of the seat, its mass, and its manufacturing cost, and also mean high maintenance costs.

Also, these kinematics limit the surface of the seat surface available for the passenger, since the width of the seat is delimited by the armrests, which laterally border the seat. Also, due to the sliding towards the front of the seat surface when the seat shifts from the seat surface position to the bed position, the sides of the seat surface are likely to abut against the shell, delimiting the seat to the front. This even more limits the seat surface width, therefore the capacity of the passenger to move in his seat.

A passenger making a flight in such a seat substantially keeps the same body parts (head, back, and rear of legs) in contact with the same surface, whether he is in the seat surface position or in the reclining position. This is likely to create strong pressure points, to prevent activation of muscles and blood circulation, and therefore to cause discomfort for the passenger during a multi-hour flight, as well as cause risks to the health of the passenger.

Also, when the seat is in the reclining position, the cushions forming the backrest, the seat surface and the leg rests can be substantially moved apart from each other in the region of their demarcation lines. The reclining position presents some discomfort for the passenger, who feels the demarcations between the different cushions of the seat under him, with the risk of the passenger being interrupted from his sleep when changing posture during sleep.

Also, the freedom of movement of the passenger in this type of seat is reduced and it is difficult for the passenger to change positions. The time period necessary for the passenger to switch from one activity (such as eating, working, reading, sleeping, resting, watching a movie, interacting with other passengers or hostesses, etc.) to another is therefore longer, and the possibilities for the passenger to perform several activities at the same time (for example eating when working with his laptop on his knees) are reduced. The passenger is therefore limited in his capacity to reproduce during flight those movements he performs in his usual environment (such as stretching out, getting up, crossing his legs, sitting down when dressed, etc.).

### PRESENTATION OF THE INVENTION

An aim of the invention is to propose a passenger seat unit for an aircraft cabin offering improved comfort for the passenger.

Another aim of the invention is to propose a passenger seat unit for an aircraft cabin offering the passenger more freedom of movement.

According to a first aspect, the invention relates to a passenger seat unit for an aircraft cabin comprising a seat surface, a backrest mounted mobile between a first position and a second position, and a leg rest mounted mobile between a first position and a second position, the seat unit having:
an upright configuration in which the backrest and the leg rest are in the first position, and
a bed configuration in which the backrest and the leg rest are in the second position, the backrest, the seat surface and the leg rest forming a substantially plane and continuous surface,
   the passenger seat unit being characterised in that:
the seat surface is fixed,
the backrest is mounted mobile in rotation between the first position and the second position around a joint axis between the backrest and the seat surface, the backrest being adapted to receive a back of a passenger when the backrest is in the first position and a head of a passenger when the backrest is in the second position,
the leg rest is mounted mobile in rotation between the first position and the second position around a joint axis between the leg rest and the seat surface.

Some preferred but non-limiting characteristics of the passenger seat unit described hereinabove are the following, taken individually or in combination:
the backrest and the leg rest are mounted mobile in rotation around respective pivot links, and wherein the rotation of the backrest is independent of the rotation of the leg rest;
the passenger seat unit further comprises a head support mounted mobile in rotation between a first position and a second position, the passenger seat unit being such that when the seat unit is in the upright configuration, the backrest and the head support are in the first position and form a substantially plane and continuous surface, and the rotation of the head support being independent of the rotation of the backrest and of the rotation of the leg rest;
the passenger seat unit further comprises a footrest adapted to be separated from the seat surface by a distance corresponding substantially to a dimension of the leg rest, such that when the seat unit is in the bed configuration, the backrest, the seat surface, the leg rest, and the footrest form a substantially plane and continuous surface;
the seat surface has a dimension in the direction of the joint axis between the backrest and the seat surface, called width, which is greater than the width of the backrest;
the passenger seat unit further comprises a front panel and a shelf adapted to be mounted on the front panel so as to be mobile in rotation around a first axis of rotation between a stowed position in which the shelf is stowed against the front panel and an open position in which the shelf is positioned substantially parallel to the seat surface so as to former a work surface for the passenger;
the shelf comprises a first tray, a second tray and a third tray, the trays being superposed, wherein the first tray is adapted to be mounted mobile in rotation around a second axis of rotation perpendicular to the first axis of rotation, and the second tray is adapted to be mounted sliding according to the first axis;
the passenger seat unit further comprises a front panel, the front panel having a recess adapted to install a screen, the screen being adapted to be inclinable relative to the plane formed by the front panel;
the passenger seat unit further comprises a side panel adapted to laterally delimit the seat unit, and further comprises a private door adapted to be mounted on the side panel sliding according to a longitudinal axis of the seat unit;
the passenger seat unit further comprises a shell module comprising a seat surface support adapted to be positioned under the seat surface, and/or side panels adapted to laterally delimit the seat unit, and/or a rear desk adapted to define a footrest of an adjacent rear seat unit, and/or a rear module adapted to define a front panel of an adjacent rear seat unit;
the seat surface support and/or the side panels and/or the desk and/or the rear module have a dimension according to the joint axis between the backrest and the seat surface which is adaptable.

According to a second aspect, the invention relates to an arrangement of passenger seat units for an aircraft cabin, comprising a plurality of passenger seat units according to the first aspect, the passenger seat units being positioned parallel behind each other, such that the bed surface extends diagonally relative to a longitudinal axis of the seat unit.

According to a third aspect, the invention relates to an arrangement of passenger seat units for an aircraft cabin, comprising a plurality of passenger seat units according to the first aspect, the passenger seat units being positioned in staggered formation, such that the bed surface extends parallel to a longitudinal axis of the seat unit.

According to a fourth aspect, the invention relates to a manufacturing process of a shell module of a passenger seat unit for an aircraft cabin according to claim 10, the process comprising the following steps:
manufacture of a shell module having a maximal shell module width,
determination of a shell module width, the determined shell module width being adapted to be compatible with a width of the aircraft cabin in which the shell module is intended to be arranged,
when the determined shell module width is less than the maximal shell module width, cutting out of the shell module so as to obtain a shell module having a width substantially equal to the determined width.

### DESCRIPTION OF THE FIGURES

Other characteristics, aims and advantages of the present invention will emerge from the following detailed description given by way of non-limiting example, which will be illustrated by the following figures:

FIGS. 1a, 1b and 1c, already commented, illustrate schematic views of a passenger seat in a seat surface position, an intermediate position and a reclining position.

FIGS. 2a and 2c illustrate schematic views in perspective of a passenger seat unit according to an embodiment of the invention, in the upright position.

FIGS. 2b and 2d illustrate schematic views in perspective of a passenger seat unit according to an embodiment of the invention, in bed position.

FIGS. 3a, 3b and 3c illustrate partial schematic views in perspective of a passenger seat unit according to an embodiment of the invention, for different positions of a shelf.

FIGS. 4a and 4b illustrate partial schematic views in perspective of a passenger seat unit according to an embodiment of the invention, for different positions of a screen and a footrest.

FIGS. 5a and 5b illustrate partial schematic views in perspective of a passenger seat unit according to an embodiment of the invention, for different positions of a private door.

FIG. 6 illustrates a schematic view in perspective of a passenger seat unit according to an embodiment of the invention.

FIGS. 7a and 7b illustrate schematic views of a passenger seat unit of modular width according to an embodiment of the invention.

FIG. 8 illustrates a schematic view in perspective of a passenger seat unit according to an embodiment of the invention.

FIG. 9 illustrates schematic views in perspective of passenger seat units according to an embodiment of the invention, of passengers being installed on these seat units.

FIGS. 10a, 10b and 10c illustrate schematic views in perspective of an arrangement of passenger seat units according to an embodiment of the invention.

FIGS. 11a and 11b illustrate schematic plan views of passenger seat units according to an embodiment of the invention arranged according to two variant embodiments.

FIG. 12 illustrates a schematic view in perspective of an arrangement of passenger seat units according to an embodiment of the invention.

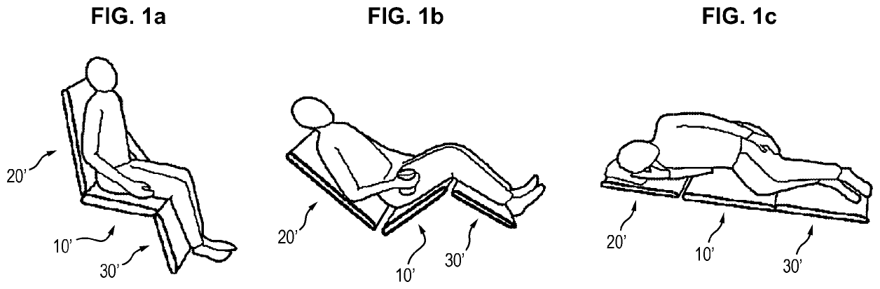

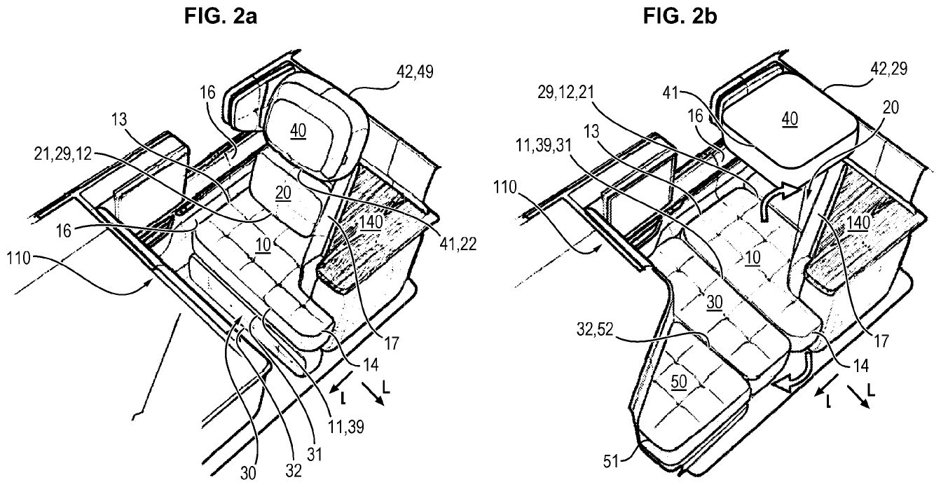

### DETAILED DESCRIPTION OF THE INVENTION

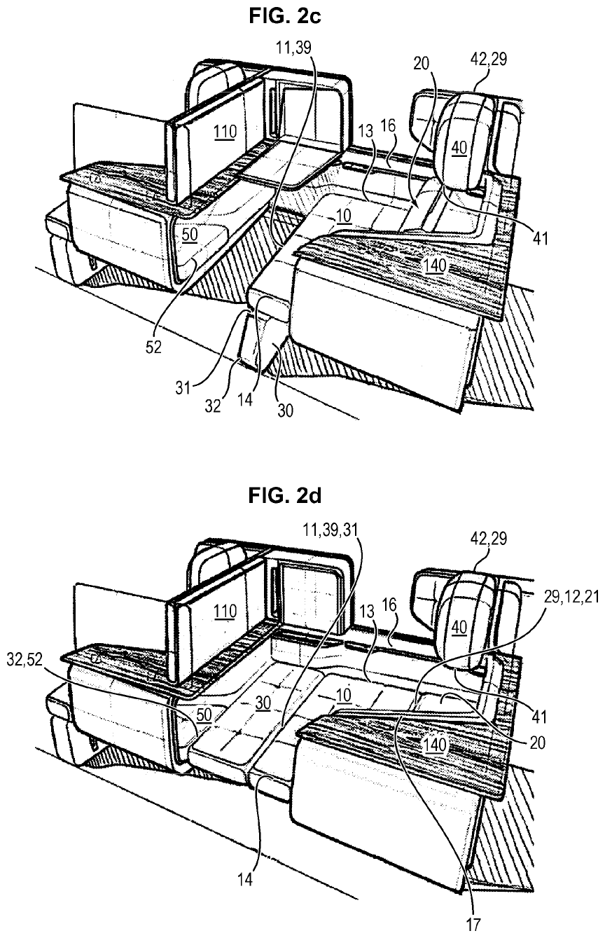

A passenger seat unit for an aircraft cabin is illustrated by way of non-limiting example in FIGS. 2a to 2d, 6 and 8.

The seat unit comprises a seat surface 10, a backrest 20 mounted mobile between a first position and a second position, and a leg rest 30 mounted mobile between a first position and a second position.

The seat unit has:
an upright configuration in which the backrest 20 and the leg rest 30 are in the first position, and
a bed configuration in which the backrest 20 and the leg rest 30 are in the second position, the backrest 20, the seat surface 10 and the leg rest 30 forming a substantially plane and continuous surface.

The passenger seat unit further has the following characteristics:
the seat surface 10 is fixed,
the backrest 20 is mounted mobile in rotation between the first position and the second position around a joint axis between the backrest and the seat surface 29, the backrest 20 being adapted to receive a back of a passenger when the backrest 20 is in the first position, and a head of a passenger when the backrest 20 is in the second position,
the leg rest 30 is mounted mobile in rotation between the first position and the second position around a joint axis between the leg rest and the seat surface 39.

A seat unit in the upright configuration is shown by way of non-limiting example in FIGS. 2a and 2c. A seat unit in the bed configuration is shown by way of non-limiting example in FIGS. 2b and 2d.

The backrest 20, the seat surface 10 and the leg rest 30 form a substantially plane and continuous surface when the seat unit is in the bed configuration. In this way, the passenger has a large flat mattress where he can stretch out comfortably in different positions. The surface of the backrest 20 is added to the surface of the seat surface 10 and to the surface of the leg rest 30 so as to maximise the total bed surface available for the passenger. When the seat unit is in the bed configuration, the passenger can stretch out so that his head is resting on the surface formed by the backrest 20.

Also, the comfort of the passenger is improved, because when in bed position the seat unit presents as a large flat mattress with no marked separation between its different elements.

The backrest 20 and the leg rest 30 are mounted mobile in rotation around joint axes, that is, they pivot around the joint axes 29, 39. Only these elements need to be actuated to shift the seat unit from the upright configuration to the bed configuration, and vice versa.

In this way, configuration of the seat unit can be modified by rotation of the backrest 20 and rotation of the leg rest 30 to adapt to the needs of the passenger during flight. In particular, the seat unit can be in upright configuration during take-off and landing, or even when the passenger is eating a meal, and be in bed configuration during cruising, for example when the passenger wants to rest or sleep.

Also, since the respective axes of rotation of the backrest 20 and of the leg rest 30 are their respective joint axes with the seat surface 29, 39, the surface of seat surface 10 is not modified by the position of the backrest 20 or of the leg rest 30, and the total surface of the seat surface 10, backrest 20 and leg rest 30 assembly is maximised when the backrest 20 and the leg rest 30 are in the second position.

Also, this type of seat unit having a fixed seat surface 10, and a backrest 20 and a leg rest 30 pivoting around respective axes of rotation 29, 39 needs no deployment kinematics such as actuators and mechanical rails to shift from the upright configuration to the bed configuration, and vice versa.

The absence of deployment kinematics substantially reduces the cost, complexity, and mass of the seat unit relative to a seat unit integrating such kinematics. This causes a resulting drop in fuel consumption for an aircraft fitted with such seat units. Also, the absence of deployment kinematics considerably reduces seat maintenance costs, due to simplification of the kinematics.

Also, the absence of deployment kinematics frees up space, in particular space under the seat.

This free space can be used for example to stow baggage under the seat, one or two suitcases, for example. In this way, baggage racks conventionally installed in spaces made in the cabin over the seats could be omitted, contributing a gain in mass and cost, as well as a cabin which is much more open and welcoming.

The absence of deployment kinematics further helps integrate into the seat unit a seat surface 10 of which the width, therefore the surface of the seat surface 10, is substantially increased. In fact, in conventional seats, the width of seat surface is limited so as not to collide with the shell of the adjacent front seat unit due to displacement of the seat surface towards the front during deployment of the seat unit towards the bed position. The increased width of seat surface therefore lets the passenger change position more easily for the same configuration of the seat unit, to have a bigger space and shift more easily from one activity to another, or carry out several activities at the same time during flight.

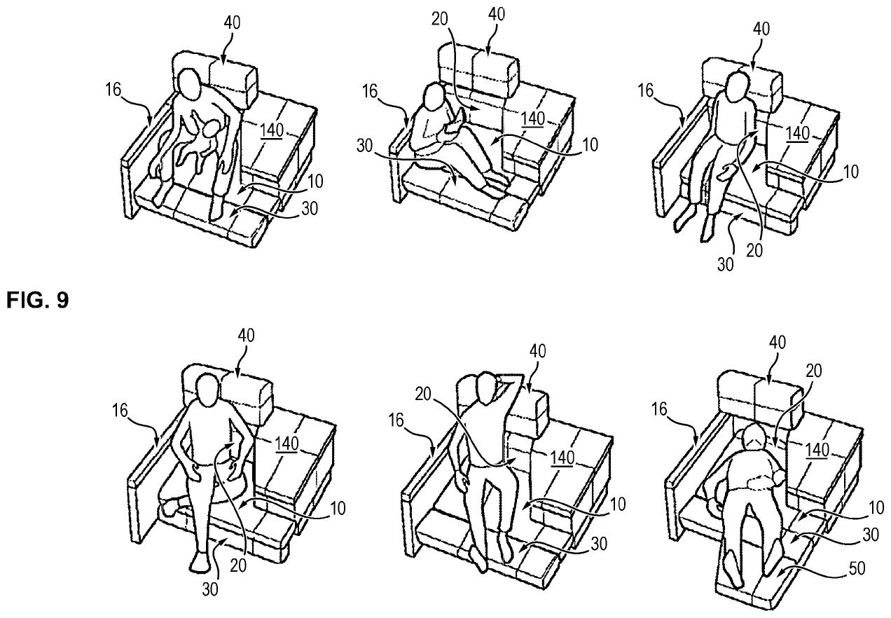

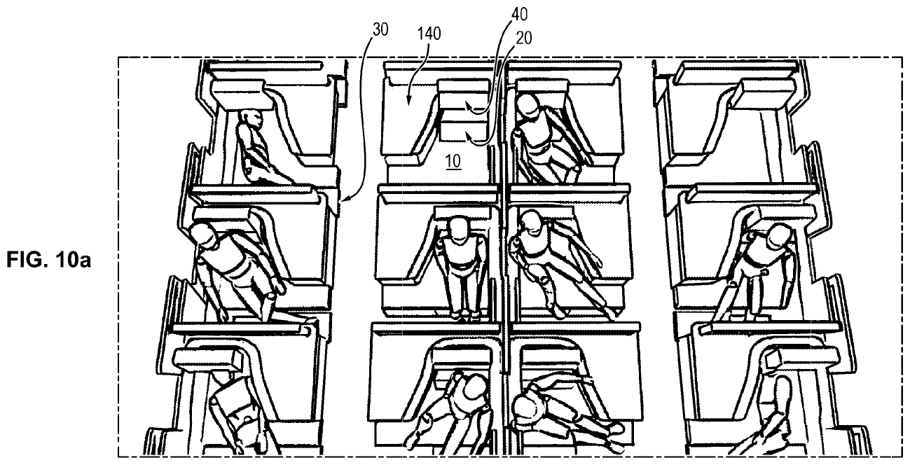

FIG. 9 illustrates examples of different positions accessible for a passenger in a seat unit. In the upright configuration of the seat unit, the passenger can for example be in seat surface position 10 with his lower back resting against the backrest 20, his thighs resting on the seat surface 10, and his calves resting near or against the leg rest 30. In the bed configuration of the seat unit, the passenger can be lying down, head resting on the backrest 20, torso resting on the seat surface 10, legs resting on the leg rest 30.

The seat unit has a longitudinal direction 1, as illustrated by way of example in FIGS. 2a, 2b and 6. The front and the rear are defined in relation to this longitudinal direction 1 such that the backrest 20 is located in a rear position relative to the leg rest 30. A dimension according to the longitudinal direction 1 is called length.

The seat unit further has a lateral direction, L, as illustrated by way of example in FIG. 2b. The lateral direction L corresponds to a direction of the joint axis between the backrest and the seat surface 29. A dimension according to the lateral direction L is called width.

The seat surface 10 is adjacent to the backrest 20 to the rear and to the leg rest 30 to the front.

The seat surface 10 is fixed, that is, reconfiguration of the seat unit by way of rotation of the backrest 20 and/or of the leg rest 30 does not modify a position of the seat surface 10.

The seat surface 10 can have a rear edge of the substantially straight seat surface 12 and a front edge of the substantially straight seat surface 11. The rear edge of the seat surface 12 coincides substantially with the joint axis between the backrest and the seat surface 29, and the front edge of the seat surface 11 coincides substantially with the joint axis between the leg rest and the seat surface 39.

The seat surface 10 can have a dimension in the direction of the joint axis between the backrest and the seat surface 29, called width, which is greater than the dimension of the backrest 20 in this same direction. The width of the seat surface 10 is therefore greater than the width of the backrest 20. Such a configuration is possible because the dimension of the seat surface 10 in the direction of the joint axis between the backrest and the seat surface 29 is not limited by the presence of lateral rails, actuators and longitudinal lateral armrests, and neither is it limited by displacement to the front of the seat surface during conversion to bed configuration, the seat surface 10 being fixed and therefore not coming to abut against the adjacent front seat unit. In this way, the surface of seat surface 10 intended to be in contact with the passenger is augmented and passenger comfort is improved.

In particular, the seat surface 10 can have a form flared towards the front, a first lateral edge of the seat surface 13 being aligned with the longitudinal axis of the seat unit, and a second lateral edge of the seat surface 14 being positioned diagonally relative to the longitudinal axis. The width of the front edge of the seat surface 11 can therefore have a width greater than the width of the rear edge of the seat surface 12. By way of example, the width of the rear edge of the seat surface 12 can correspond to a width of seat surface of a seat unit comprising deployment kinematics needing rails and actuators, and the width of the front edge of the seat surface 11 can be augmented by around 50% relative to the width of the rear edge of the seat surface 12.

The seat unit can comprise two armrests 16, 17 laterally delimiting the seat surface 10. A longitudinal armrest 16 can be positioned in the region of the first lateral edge of the seat surface 13, and a diagonal armrest 17 can be positioned in the region of at least one part of the second lateral edge of the seat surface 14. The bed surface of such a seat unit is therefore augmented relative to a bed surface of a seat having classic deployment kinematics with two longitudinal armrests laterally delimiting the seat surface 10.

In this way, the seat unit offers additional positions relative to a seat with two longitudinal armrests. When the seat unit is in the upright position, the passenger can for example be seated and oriented along the longitudinal axis, the back resting against the backrest 20 and the thighs against the seat surface 10, then pivot in his seat to sit in the width of the seat unit, for example by leaning back on the longitudinal armrest 16. If appropriate, the passenger can also make the leg rest 30 pivot in the second position to then have an additional surface for placing his feet or changing position. When the seat unit is in the bed position, the passenger can be supine diagonally relative to the longitudinal axis of the seat.

The longitudinal armrest 16 can laterally delimit the entire seat surface 10. The diagonal armrest 17 can laterally delimit a rear part of the seat surface, a front part of the seat surface having no diagonal armrest. The rear part of the seat surface can be substantially trapezoidal and flared towards the front, and the front part of the seat surface can be in lozenge form.

The width of the front part of the seat surface can be augmented relative to the width of the rear part of the seat surface, and can correspond substantially to a width of the leg rest 30. The seat surface 10 therefore comprises a part located outside the diagonal armrest 17, further increasing its total surface.

The backrest 20 can have a first backrest edge 21 coinciding substantially with the joint axis between the backrest and the seat surface 29, and a second backrest edge 22 opposite the first edge 21.

The backrest 20 is mounted in rotation around the joint axis between the backrest and the seat surface 29. The backrest 20 can be mounted mobile in rotation about a pivot link of backrest 20, the axis of the pivot link corresponding to the joint axis between the backrest and the seat surface 29. The backrest 20 can be shifted from the first position to the second position by rotation towards the rear around the joint axis between the backrest and the seat surface 29.

Rotation of the backrest 20 between the first and second positions can correspond to angle rotation between 70° and 110°, preferably between 80° and 100°, preferably around 90°.

The backrest 20 can further have a plurality, or even a continuum, of intermediate positions between the first position and the second position, that is, corresponding to rotation of the backrest 20 having an angle between 0° and the angle of rotation between the first position and the second position. For example, the backrest 20 can be inclined relative to the first position by an angle of 30°, or even 45°, or 70°.

The backrest 20 can also have a plurality, or even a continuum, of positions beyond the first and second positions, corresponding to rotation towards the front relative to the first position, or to rotation towards the rear relative to the second position. A continuum of positions of the backrest 20 between or beyond the first and second positions lets the passenger adjust the inclination of the backrest 20 to find optimal comfort adapted to any kind of activity he undertakes during the flight.

The joint axis between the backrest and the seat surface 29 corresponds to an axis of articulation of the backrest 20 relative to the seat surface 10, that is, to an interface between the backrest 20 and the seat surface 10. The joint axis between the backrest and the seat surface 29 can be an axis substantially perpendicular to the longitudinal axis, forming a horizontal plane with the longitudinal axis.

In the first position, the backrest 20 can extend substantially in a plane normal to the longitudinal direction 1 of the seat unit, called vertical plane. By way of variant, when the backrest 20 is in the first position, the backrest 20 can be inclined by a few degrees, towards the front or towards the rear, relative to the vertical plane.

In the second position, the backrest 20 extends substantially in the horizontal plane of the seat unit.

The leg rest 30 can have a first edge of leg rest 31 coinciding substantially with the joint axis between the leg rest and the seat surface 39, and a second edge of leg rest 32 opposite the first edge 31.

The leg rest 30 can be mounted mobile in rotation about a pivot link of leg rest 30, the axis of the pivot link corresponding to the joint axis between the leg rest and the seat surface 39. The leg rest 30 can be shifted from the first position towards the second position by rotation towards the front around the joint axis between the leg rest and the seat surface 39.

Rotation of the leg rest 30 between the first and second positions can correspond to angle rotation between 70° and 110°, preferably between 80° and 100°, preferably around 90°.

The leg rest 30 can further have a plurality, or even a continuum, of intermediate positions between the first position and the second position, that is, corresponding to rotation of the leg rest 30 between 0° and the angle of rotation between the first position and the second position. For example, the leg rest 30 can be inclined relative to the first position by an angle of 30°, or again 45°, or 70°.

The leg rest 30 can also have a plurality, or even a continuum, of end positions corresponding to rotation towards the rear relative to the first position, or to rotation towards the front relative to the second position.

The joint axis between the leg rest and the seat surface 39 can be an axis substantially perpendicular to the longitudinal axis and parallel to the joint axis between the backrest and the seat surface 29.

In the first position, the leg rest 30 can extend substantially in the vertical plane. By way of variant, when the leg rest 30 is in the first position, the leg rest 30 can be inclined by a few degrees towards the front or towards the rear relative to the vertical plane.

In the second position, the leg rest 30 extends substantially in the horizontal plane of the seat unit. For example, the seat unit can be shifted into a configuration where the backrest 20 is in the first position and the leg rest 30 in the second position, the passenger being able for example to be seated with his legs stretched out and/or his feet resting on the leg rest 30.

A space is further made behind the leg rest 30 when the latter is in the first position. This space to the rear of the leg rest 30 under the seat is available because the seat unit comprises no actuators or actuation rails. In this way, baggage can be stowed behind the leg rest 30. This helps to stow more baggage, or even omit baggage stowage spaces conventionally arranged in the upper part of the aircraft cabin.

The leg rest 30 can comprise two adjacent parts, each being mobile in rotation around the joint axis between the leg rest and the seat surface 39. The two parts are positioned side by side in the lateral direction L. Rotation of the two parts around the joint axis between the leg rest and the seat surface 309 can be independent. In this way, the passenger can raise or lower just one part of the leg rest 30.

Rotation of the backrest 20 can be independent of the rotation of the leg rest 30. In this way, the backrest 20 can be shifted in rotation from one position to another, and a leg rest 30 can be kept fixed, and vice versa. In this way, the number of configurations accessible to the seat unit is further increased, which heightens the comfort of the passenger who can adapt the seat unit more to his needs during flight. By way of variant, rotation of the backrest 20 can be linked to that of the leg rest 30, both rotations being synchronised so that when the backrest 20 is shifted from the first position to the second position, the leg rest 3à is also shifted from the first position to the second position, and vice versa.

When the seat unit is in the bed configuration, the first edge of leg rest 31 is adjacent to the front edge of the seat surface 11, and the rear edge of the seat surface 12 is adjacent to the first backrest edge 21.

The seat surface 10 can have a trapezoidal form. A smaller base of the seat surface 10 delimits a joint between the seat surface 10 and the backrest 20, a larger base of the seat surface 10 delimits a joint between the seat surface 10 and the leg rest 30, a first lateral edge of the seat surface 13 is longitudinal and a second lateral edge of the seat surface 14 is diagonal, the two lateral edges of the seat surface 13, 14 being delimited by respective armrests 16, 17.

The joint axis between the leg rest and the seat surface 39 is parallel to the joint axis between the backrest and the seat surface 29. When the seat unit is in the upright configuration, the leg rest 30 and the backrest 20 are substantially parallel and extend in the vertical plane. When the seat unit is in the bed configuration, the leg rest 30 and the backrest 20 are substantially parallel and extend in the horizontal plane, with the backrest 20, the seat surface 10 and the leg rest 30 forming a substantially horizontal and continuous surface.

By way of non-limiting example, FIG. 9 illustrates different positions accessible for a passenger on a seat unit such as described hereinabove.

The seat unit can further comprise a head support 40. The head support 40 is mounted mobile in rotation between a first position and a second position around a head support axis of rotation 49. Rotation of the head support 40 is independent of rotation of the backrest 20 and of rotation of the leg rest 30.

When the backrest 20 and the head support 40 are in the first position, the backrest 20 and the head support 40 can be substantially parallel to each other and located in the same plane. By way of variant, the head support 40 in the first position can be inclined towards the rear, by a few degrees for example, relative to the backrest 20 in the first position. When the backrest 20 and the head support 40 are parallel to each other, they can be separated from each other by a space, or form a substantially plane and continuous surface.

The head support 40 can have a first head support edge 41 and a second head support edge 42 opposite the first edge 41. The second head support edge 42 coincides substantially with the head support axis of rotation 49. The width of the head support 40 can be between a width of the backrest 20, and a width of the seat unit.

The head support 40 can be mounted mobile in rotation about a pivot link of a head support 40, the axis of the pivot link corresponding to the head support axis of rotation 49. The head support 40 can be shifted from the first position to the second position by rotation towards the front around the head support axis of rotation 49. The head support axis of rotation 49 can be an axis substantially perpendicular to the longitudinal axis and parallel to the joint axis between the backrest and the seat surface 29.

In the first position, the head support 40 can extend in the vertical plane. By way of variant, in the first position, the head support 40 can be inclined by a few degrees towards the front or towards the rear, relative to the vertical plane.

When the seat unit is in the upright position, the head support 40 and the backrest 20 are both in the first position. Therefore, the first head support edge 41 coincides substantially with the second edge of the backrest 22, the head support 40 and the backrest 20 having substantially the same inclination. In this way, the head support 40 prolongs the backrest 20 and with it forms a substantially vertical and continuous surface so as to offer an additional support surface for the back and the head of the passenger.

In the second position, the head support 40 extends substantially in the horizontal plane of the seat unit.

When the seat unit is in the bed configuration, the head support 40 can be shifted by the passenger to the second position so as to be located above the head of the passenger when the latter is lying down on the bed formed by the leg rest 30, the seat surface 10 and the backrest 20. The head support 40 creates a private space for the passenger, lowers the luminosity inside this space by preventing light rays from penetrating, and improves sound insulation within this space, which contributes to improving comfort for the passenger.

The seat unit can comprise a footrest 50. The footrest 50 is adapted to be separated from the seat surface 10 by a distance corresponding substantially to a dimension of the leg rest 30, such that when the seat unit is in the bed configuration, the backrest 20, the seat surface 10, the leg rest 30 and the footrest 50 form a substantially plane and continuous surface. In this way, the bed surface of the seat unit, formed by the backrest 20, the seat surface 10 and the leg rest 30, is prolonged by the footrest 50. The presence of the footrest 50 therefore boosts the total surface available for the passenger in the bed configuration.

In a first embodiment, the footrest 50 is fixed, that is, reconfiguration of the seat unit by way of rotation of the backrest 20 and/or of the leg rest 30 does not modify a position of the footrest 50.

The footrest 505 can have a surface intended to be in contact with the passenger who is substantially parallel to the seat surface 10, can have a substantially straight front edge of a footrest 51, and a substantially straight rear edge of a footrest 52.

The footrest 50 can be separated from the seat surface 10 by a distance corresponding substantially to the length of the leg rest 30. The footrest 50 is positioned such that when the leg rest 30 is in the second position, the rear edge of the footrest 52 coincides substantially with the second edge of the leg rest 30.

The axis of delimitation between the leg rest 30 and the footrest 50 can be substantially parallel to the joint axis between the leg rest and the seat surface 39 and/or to the joint axis between the backrest and the seat surface 29.

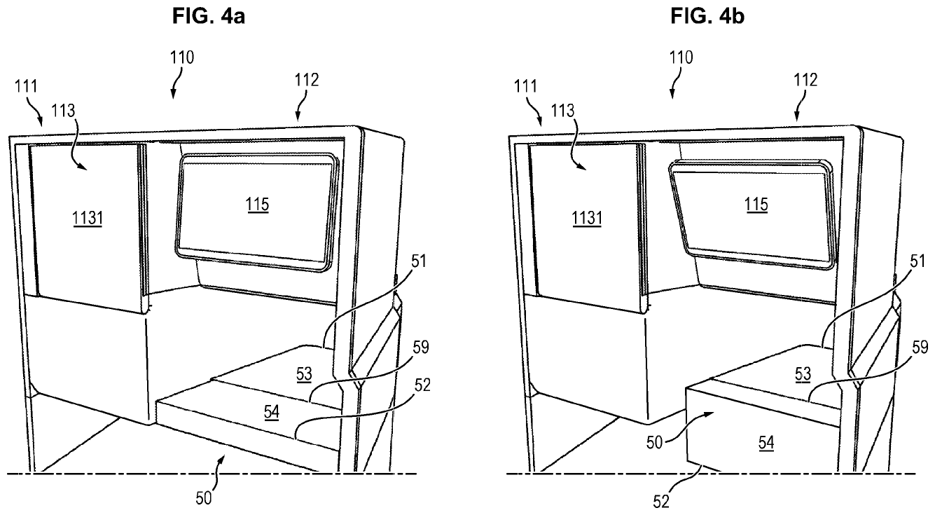

In a second embodiment, the footrest 50 is mobile, as illustrated by way of non-limiting example in FIGS. 4a and 4b. The footrest 50 comprises a front part of footrest 53 and a rear part of footrest 54. The front part of footrest 53 is separated from the seat surface 10 by a distance corresponding to a combined length of the rear part of footrest 54 and of the leg rest 30.

The front part of footrest 53 is fixed and substantially parallel to the seat surface 10. The rear part of footrest 54 is mobile in rotation, for example in rotation towards the front between a first position and a second position. The axis of rotation of the rear part of footrest 54 corresponds to a joint axis between the front part of footrest 53 and the rear part of footrest 54.

In the first position, the rear part of footrest 54 extends substantially in the vertical plane. In the second position, the rear part of footrest 54 extends substantially in the horizontal plane. The rear part of footrest 54 is adjacent to the front part of footrest 53 and forms a substantially horizontal, plane and continuous surface with the front part of footrest 53 and the leg rest 30 in the second position.

Such a footrest 50 having a fixed front part of footrest 53 and a rear part of footrest 54 mobile in rotation increases the number of possible configurations of the seat unit. For example, when the passenger wants to leave his seat to move about in the aircraft, or return to his seat after moving about, he may want to position the seat unit in upright configuration and the rear part of footrest 54 in the second position. In this way, space is freed up between the seat surface 10 and the footrest 50, and the passenger has more space for getting out of the seat or sitting down in it.

The backrest 20 and/or the leg rest 30 can be shifted between the positions which are accessible to it by action of the passenger. In a first exemplary embodiment, the passenger shifts the backrest 20 and/or the leg rest 30 by pressing on one or more control buttons of the backrest 20 and/or of the leg rest 30, the button(s) being located for example on a lever incorporated into the seat, or again on a remote. For example, a first button can control rotation of the backrest 20, and a second button can control rotation of the leg rest 30, both rotations being independent. A third button can control simultaneous synchronised rotation of the backrest 20 and of the leg rest 30. By way of variant, a single button can control rotations, independent or simultaneous, of the backrest 20 and/or of the leg rest 30. The button/buttons controls/control one or more electric actuators or one or more gas or hydraulic pistons, for example an actuator or piston for the backrest 20 and an actuator or piston for the leg rest 30. The actuator(s) or piston(s) in return controls/control rotation of the backrest 20 and/or of the leg rest 30. In a second exemplary embodiment, the passenger shifts the backrest 20 and/or the leg rest 30 by exerting mechanical pressure manually on the backrest 20 and/or the leg rest 30.

The backrest 20, the seat surface 10 and the leg rest 30, and if appropriate the footrest 50 and the head support 40, and the armrests 16, 17, can each comprise a cushion. The cushion can be made of material such as soft fabric, or plastic or leather. A cushion comprises a foam, the foam being designed to fit in with the foam of an adjacent cushion. In this way, the passenger does not feel the joint between the different foams and the different cushions under him, heightening his comfort. The surfaces of these elements intended to be in contact with the passenger can be formed by surfaces of respective cushions. Each of these surfaces can be substantially plane, or even slightly rounded.

The assembly formed by the backrest 20, the seat surface 10 and the leg rest 30 when the seat unit is in the first configuration can have a length between 30 inches and 60 inches, preferably between 40 inches and 55 inches, this length being called length of the seat unit. In particular, the length of the seat unit can be 50 inches, or even be 44 inches. A length of 50 inches boosts the dimension of the seat unit, the surface defined by the seat surface 10 and the bed surface, and therefore heightens the comfort of the passenger. A length of 44 inches ensures compatibility of the seat unit with the restrictions and standards of the dimensioning of contemporary cabins.

The seat unit can further comprise a front panel 110. The front panel 110 can extend substantially in the vertical plane. The front panel 110 can be located in a more advanced position than the seat surface 10 of the seat unit.

The front panel 110 can comprise a first part 111 and a second part 112, the two parts 111, 112 being adjacent and oriented substantially according to the vertical plane. The second part 112 forms a recess towards the front relative to the first part 111.

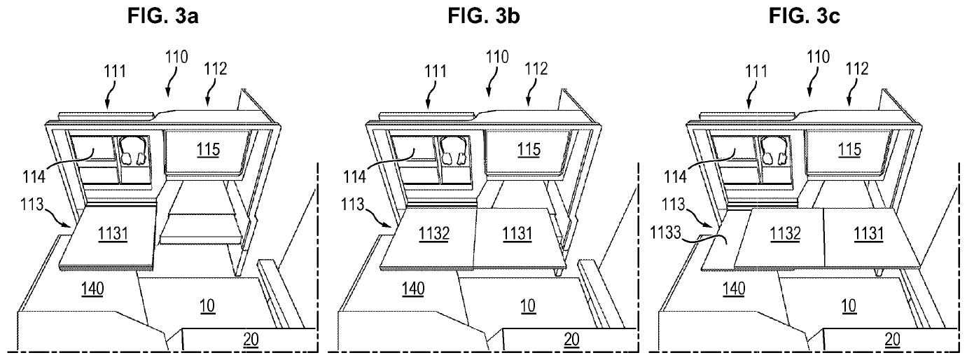

The seat unit can further comprise a shelf 113 adapted to be mounted on the front panel 110 so as to be mobile in rotation around a first axis of rotation between a stowed position in which the shelf 113 is stowed against the front panel 110 and an open position in which the shelf 113 is positioned substantially parallel to the seat surface 10 so as to form a work surface for the passenger. In particular, the shelf 113 can be attached to the first part 111 of the front panel 110. A shelf of the seat unit is illustrated by way of non-limiting example in FIGS. 3a, 3b and 3c.

The shelf 113 can comprise a first tray 1131, a second tray 1132 and a third tray 1133, the trays being superposed, that is, stacked on each other, the second tray 1132 being sandwiched between the first tray 1131 and the third tray 1133. The three trays of the shelf 113 can pivot in a single block between the stowed position and the open position.

The first axis of rotation of the shelf 113 can be parallel to the joint axis between the backrest and the seat surface 29. In this way, the shelf 113, in particular each of its trays, can extend substantially in a vertical plane when the shelf 113 is in the stowed position, and in a horizontal plane when the shelf 113 is in the open position.

The first tray 1131 can be mounted mobile in rotation around a second axis of rotation perpendicular to the first axis of rotation. The second axis of rotation can correspond substantially to the longitudinal axis. In this way, when the shelf 113 is in the open position, the first tray 1131 can be unfolded to form a substantially horizontal plane and continuous surface with the second tray 1132, the second tray 1132 being positioned in contact with the third tray 1133 and covering the third tray 1133. The first tray 1131 of the shelf 113 can be attached to the second tray 1132 by way of hinges.

The second tray 1132 is adapted to be mounted sliding according to the first axis. In this way, when the shelf 113 is in the open position and the first tray 1131 is unfolded, the second tray 1132 can be deployed to uncover the third tray 1133 at least partially, or even entirely. The second tray 1132 can be mounted for example sliding on the third tray 1133 by way of rails located on the first tray 1131 or laterally to the third tray 1133, the rails guiding the sliding of the second tray 1132.

When the first tray 1131 is unfolded and the second tray 1132 is deployed, the first tray 1131 and the second tray 1132 form a substantially horizontal and continuous surface, and the third tray 1133 is uncovered at least partially, or even completely. The total work surface available for the passenger in this configuration of the shelf 113 is therefore enlarged. Also, this work surface is easily reconfigurable by the passenger as a function of his activities during flight, by simple rotation and sliding of the trays.

To lower the shelf 113 when the latter is fully deployed, the second tray 1132 is translated along the first axis, then the first tray 1131 is folded back by rotation around the second axis, and finally the block formed by the three trays is lowered by rotation around the first axis. Inverse kinematics passes from a stowed shelf 113 to a fully deployed shelf 113.

Also, the front panel 110 can have a storage space 114, the storage space 114 being covered up by the shelf 113 in the stowed position, and uncovered when the shelf 113 is in the open position. In this way, the storage space 114 is accessible to the passenger when the shelf 113 is in the open position. This storage space 114 can be utilised for storing items provided to the passenger during flight, such as headsets, or sleeping kits. The passenger can also store personal items there.

The front panel 110 can have a recess adapted to install a screen physical 115. This recess can correspond to the second part 112 of the front panel 110. The recess can be located substantially to the vertical of the footrest 50 when the seat unit comprises a footrest 50.

The screen 115 can be mounted in rotation according to an axis of rotation of the screen 119, so as to be inclinable relative to the plane formed by the front panel 110. For example, the axis of rotation of the screen 119 can be substantially parallel to the joint axis between the backrest and the seat surface 29. In this way, the inclination of the screen 115 can be adapted as a function of the template of the passenger, of his position in the seat unit, etc. An inclinable screen 115 applied to a front panel 110 is illustrated by way of non-limiting example in FIGS. 4a and 4b.

The screen 115 can be inclined towards the front, so as to free up space near the footrest 50, for example for the knees of a passenger sitting in the seat unit. Also, the screen 115 is then positioned fully adapted opposite the eyes of a passenger who himself is inclined, for example when the seat unit is in an intermediate configuration between the upright configuration and the bed configuration. The screen 115 can be inclined towards the front as far as an angle of around 30°, for example of around 22°.

The screen 115 can be inclined towards the front, for example to be positioned fully adapted opposite the eyes of a passenger of large size, sitting in a seat unit in an upright configuration. The screen 115 can be inclined to the rear up to an angle of around 20°, for example of around 30°, for example of around 22°.

The seat unit can further comprise one or more side panels 120 adapted to laterally delimit the seat unit. The side panels 120 delimit a width of the seat unit. The side panels 120 can be parallel and spaced apart by a distance greater than the distance separating the armrests 16, 17.

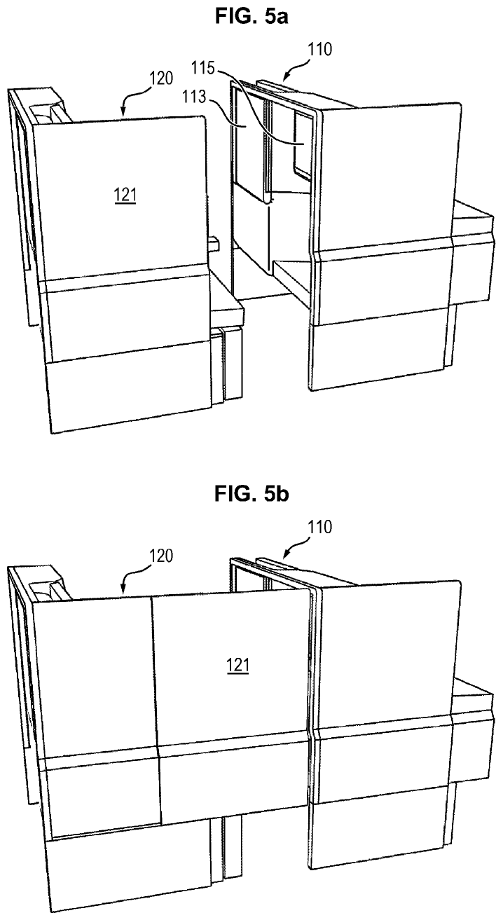

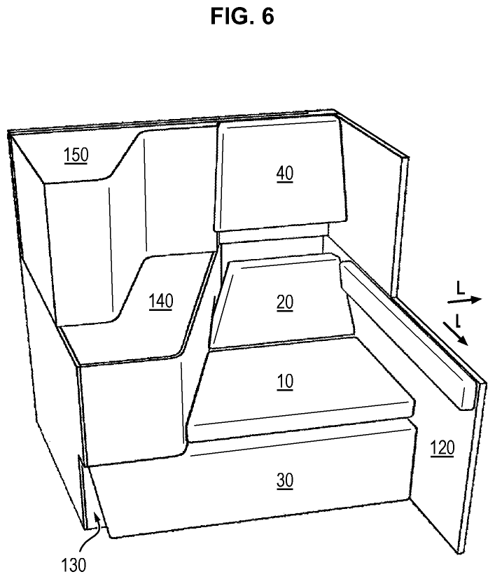

A side panel 120 can comprise a private door 121 adapted to be mounted on the side panel 120 sliding according to a longitudinal axis of the seat unit. A private door 121 applied to a side panel 120 is illustrated by way of non-limiting example in FIGS. 5a and 5b. The private door 121 can be slid between a position where the door covers the side panel 120, the private door 121 then forming an additional thickness in contact with the side panel 120, and a position where the private door 121 uncovers the side panel 120, the private door 121 accordingly extending the side panel 120 such that the passenger has a private space separate from the rest of the cabin.

The private door 121 can be embedded in the side panel 120. In this way, the assembly formed by the side panel 120 and the private door 121 exhibits less thickness than an assembly comprising a door sandwiched between two walls of a caisson of a side panel 120. The mass and cost of the assembly is therefore reduced. Also, the private door 121 constitutes an independent module which can be attached to the panel or not, according to the needs of the arrangement of the cabin.

The seat unit can include an overhead projector. The overhead projector can be integrated into a front panel 110 of an adjacent rear seat unit. The physical screen 115 is then phased out, and the recess of the front panel 110 housing the physical screen 115 can be released so as to augment the space available for the passenger.

Projection can be effected on a substantially plane projection surface located in front of the passenger. The projection surface can cover part or all of the width of the seat, the projection surface being augmented relative to the surface of a physical screen 115. The projection surface can be that of one or more folding shelves for example. A shelf 113 is mobile in rotation between a vertical position in which the shelf 113 forms a projection surface, and a horizontal position in which the shelf 113 forms a work surface of consistent dimensions, the projection surface being ensured by the front panel 110.

The projection surface can be between 20 inches and 50 inches, and can preferably be close to 39 inches. In this way, the projection surface is much greater than the surface of a physical screen 115 such as integrated into a classic seat unit.

The seat unit can further comprise a shell module. The shell module can comprise a seat surface support 130 adapted to be positioned under the seat surface 10, and/or side panels 120 adapted to laterally delimit the seat unit, and/or a rear desk 140 adapted to define a footrest 50 of an adjacent rear seat unit, and/or a rear module 150 adapted to define a front panel 110 of an adjacent rear seat unit.

The seat surface support 130 can be in the form of a caisson located under the seat surface 10. The rear desk 140 can define a projection located in front relative to the rear module 150, and be located substantially in the region of an elbow of a passenger sitting in the seat unit in the upright configuration. The rear module 150 can have a part located recessed so as to receive the backrest 20 in the bed configuration of the seat unit.

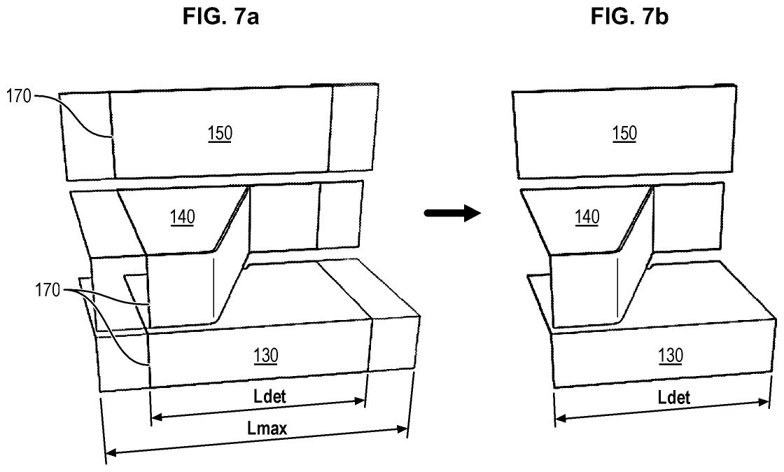

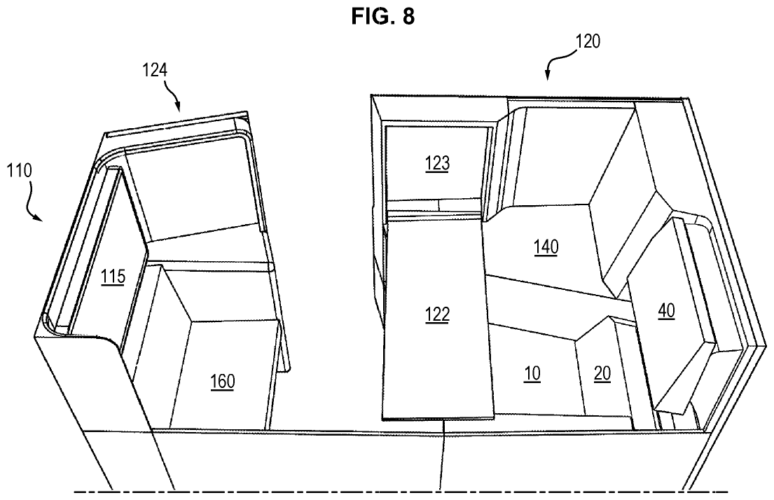

The seat surface support 130 and/or the side panels 120 and/or the desk 140 and/or the rear module 150 can have a dimension according to the joint axis between the backrest and the seat surface 29, in other words a width which is adaptable. FIGS. 7a and 7b illustrate a non-limiting example of a shell module for a seat unit having an adaptable width. The width of the shell module can therefore be adapted as a function of a width of a cabin in which the seat unit is arranged. The seat unit can therefore be installed in a large number of existing types of aircraft having different cabin widths.

A single seat unit shell module, shown by way of non-limiting example in FIGS. 6, 7a and 7b, needs to be designed and manufactured. The shell module can for example be made by moulding. The manufactured shell module corresponds to the largest template in width of each of its elements, specifically to a maximal width of its seat surface support 130 and/or of its side panels 120 and/or of its desk 140 and/or of its rear module 150. The manufactured shell module therefore has a maximal shell module width Lmax.

The shell module can have one or more cut-out areas 170 extending in the longitudinal direction. The cut-out lines correspond to one or more possible widths of shell module, less than the maximal shell module width Lmax.

A determined shell module width Ldet corresponding to a shell module width compatible with a width of a cabin in which the shell module is intended to be arranged is determined. The single manufactured shell module can then be cut out along its cut-out lines, when the maximal shell module width Lmax is greater than the determined shell module width Ldet.

The costs for development and manufacture of the seat unit are substantially reduced, because a single shell module is designed and developed, then cut out to adapt its width.

It is also possible to ensure that the desk 140 can be oriented in the horizontal plane so as to allow angular adaptation of the shell module to the cross-section of the aircraft. The orientation of the desk 140 in the horizontal plane modifies demarcation with the seat surface 10, and orientation of the footrest of the adjacent rear seat unit.

A manufacturing process of a shell module of a passenger seat unit for an aircraft cabin can comprise the following steps:
manufacture of a shell module having a maximal shell module width Lmax,
determination of a shell module width Ldet, the determined shell module width Ldet being adapted to be compatible with a width of the aircraft cabin in which the shell module is intended to be arranged,
when the determined shell module width Ldet is less than the maximal shell module width Lmax, cutting out of the shell module so as to obtain a shell module having a width substantially equal to the determined width Ldet.

In a first variant embodiment, the seat unit comprises a front panel 110 of the type described hereinabove and comprises a shelf 113 mobile between the first position and the second position. When the shelf 113 is in the second position, the third tray 1133 of the shelf can rest on the rear desk 140. In this way, the stability of the shelf 113 is improved, allowing the passenger to put more weight on the shelf 113.

In a second variant embodiment, illustrated by way of non-limiting example in FIG. 8, the seat unit defines a mini-suite. In particular, this can be the case for a seat unit positioned in the region of the very front row of the aircraft. In fact, an additional length is available in the region of the very front row of the aircraft.

The total length of the mini-suite can be greater than the length of the seat unit according to the first variant embodiment. The side panels of the mini-suite have a length greater than the length of the side panels 120 of a seat unit according to the first variant embodiment. Side shelves 122 can be attached to one and/or the other of the side panels 120, the side shelves 122 being mobile in rotation around the longitudinal axis between a stowed vertical position and a deployed horizontal position. The side shelves 122 in particular can have a structure substantially similar to the structure of the shelf 113 of the front panel 110 so as to be able to form a modular work surface. Storage spaces 123 can be made in the lateral panel, the storage spaces 123 being accessible to the passenger when the side shelves 122 are in the deployed position.

The front panel of the mini-suite can have a recess adapted to receive an additional passenger seat 160, located opposite the backrest 20, the seat surface 10 and the leg rest 30 forming the principal passenger seat unit described hereinabove. The additional passenger seat 160 can be for example in the form of a bench comprising a fixed backrest and a seat surface, or of a seat unit substantially similar to the principal seat unit. A physical screen 115 can be attached to the front panel above the backrest of the additional passenger seat 160, the screen 115 extending substantially in the vertical plane. By way of variant, the surface formed by the front panel above the backrest of the additional passenger seat 160 can form a projection surface for an overhead projector attached to a rear module 150 of the [symbol] .

The additional passenger seat 160 can comprise a leg rest mobile between a vertical position and a horizontal position. In the horizontal position, the leg rest of the additional passenger seat 160 forms a substantially horizontal and continuous surface with the seat surface of the additional seat 160. When the leg rest of the additional seat 160 is in horizontal position and the leg rest 30 of the principal seat unit is in the second position, the two leg rest can form a substantially horizontal and continuous surface. In this way, the passenger has a bed having a surface, and especially a length, further increased.

A private door sliding can be attached to a side wall of the front panel 124. The private door can slide so as to prolong the side wall of the front panel 124. In this way, the space constituting the mini-suite can be totally isolated from the rest of the cabin, offering the passenger improved comfort.

The rear panel of the mini-suite can define a front panel 110 of a seat unit according to the first variant embodiment, arranged to the rear of the mini-suite.

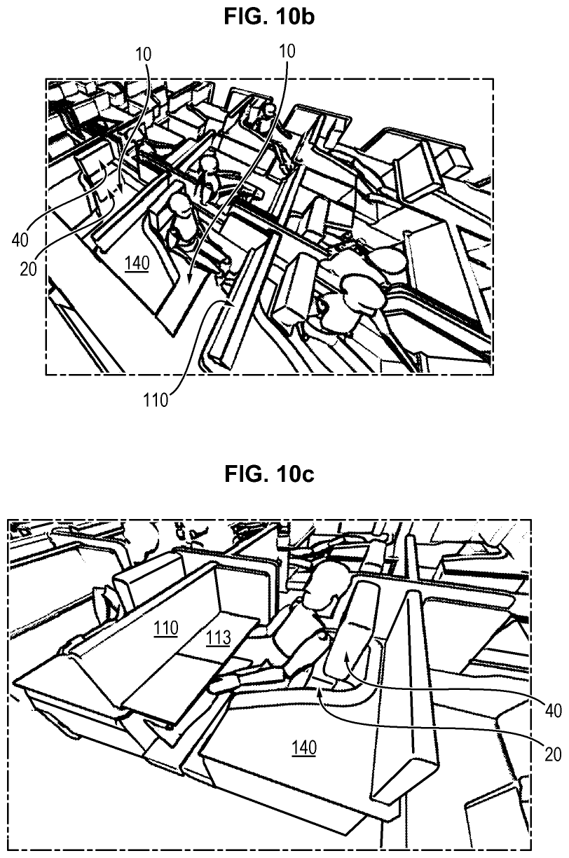

Several passenger seat units can be arranged to form an arrangement of a plurality of passenger seat units, as shown by way of non-limiting example in FIGS. 10a to 10c, and 12.

The arrangement of passenger seat units is intended to be installed in an aircraft cabin. The cabin can comprise several rows of seat units, each row capable of comprising two seat units, or four seat units for example. The cabin has a cabin axis extending from a nose of the aircraft to a tail of the aircraft.

According to a first exemplary embodiment, illustrated by way of non-limiting example in FIGS. 10a to 10c, 11a and 12, the seat units are positioned parallel behind each other (‘herringbone’ configuration). The longitudinal axis 11 of a seat unit is parallel to the longitudinal axis 12 of an adjacent rear seat unit. The longitudinal axis 11, 12 of seat unit can correspond to a cabin axis. In this way, the bed surface of a seat unit in the bed configuration extends substantially diagonally relative to the cabin axis and to the longitudinal axis of the seat unit, the bed surfaces of the seat units being positioned in herringbone.

Two seat unit sets positioned on either side of the cabin axis can be positioned to mirror each other. In this way, the bed surface of a seat unit of one side of the cabin axis extends diagonally according to an orientation opposite the bed surface of a seat unit located of the other side of the cabin axis.

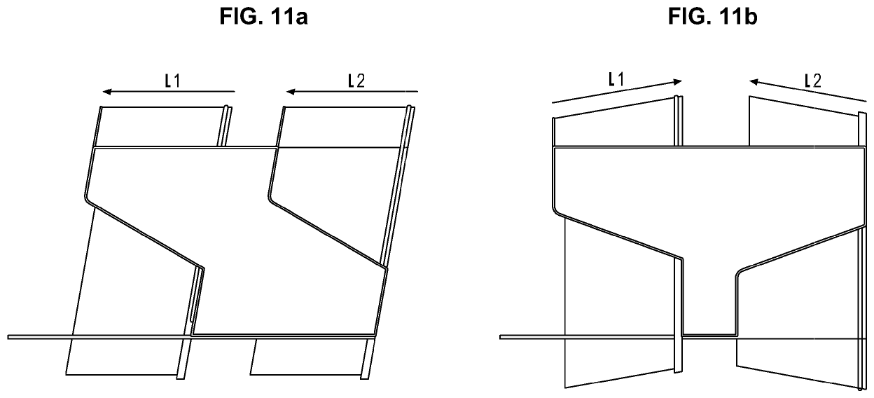

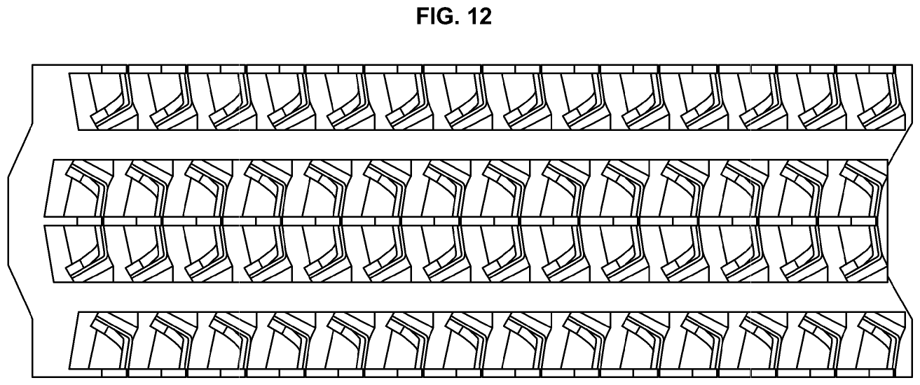

According to a second exemplary embodiment, illustrated by way of non-limiting example on the FIG. 11b, the seat units can be positioned in staggered formation (‘staggered’ configuration). The longitudinal axis 11 of a seat unit can exhibit an inclination relative to the cabin axis, and the longitudinal axis 12 of an adjacent rear seat unit can exhibit an opposite inclination relative to the cabin axis. Two seat unit assemblies positioned to the front and to the rear of each other are positioned to mirror each other. In this way, the bed surface of a seat unit in the bed configuration extends substantially in the direction of the cabin axis.

A seat unit can be anchored on cabin rails located under the seat surface module 10, in particular by way of a low structure of the seat unit. The low structure can be positioned under the seat surface structure 130 and/or the desk 140, and comprise an upper mechanical link and feet adapted to be anchored in the cabin rails, in particular two feet adapted to be anchored in two cabin rails positioned parallel to the cabin axis. The upper mechanical link can for example comprise two parallel tubes which can be positioned substantially perpendicularly relative to the cabin rails. The feet can be attached to the upper mechanical link, in particular can be mounted sliding along the tubes so as to adapt their position and their spacing as a function of the arrangement of the cabin rails where they must be anchored. In this way, the low structure adapts the anchoring of the seat unit to different spacings of cabin rails, the spacing of the rails being likely to vary as a function of the type of aircraft and/or the central or lateral position of the seat unit in the cabin.

Anchoring of the seat unit has a mass and complexity substantially reduced relative to a seat unit having deployment kinematics. In fact, the seat unit is much lighter than a seat unit having deployment kinematics.

1. A passenger seat unit for an aircraft cabin, comprising a seat surface, a backrest mounted mobile between a first position and a second position, and a leg rest mounted mobile between a first position and a second position, the seat unit having:
an upright configuration in which the backrest and the leg rest are in the first position, and
a bed configuration in which the backrest and the leg rest are in the second position, the backrest, the seat surface and the leg rest forming a substantially plane and continuous surface, wherein:
the seat surface is fixed,
the backrest is mounted mobile in rotation between the first position and the second position around a joint axis between the backrest and the seat surface, the backrest being adapted to receive a back of a passenger when the backrest is in the first position and a head of a passenger when the backrest is in the second position,
the leg rest is mounted mobile in rotation between the first position and the second position around a joint axis between the leg rest and the seat surface.

2. The passenger seat unit according to claim 1, wherein the backrest and the leg rest are mounted mobile in rotation around respective pivot links, and wherein the rotation of the backrest is independent of the rotation of the leg rest.

3. The passenger seat unit according to claim 1, further comprising a head support mounted mobile in rotation between a first position and a second position, wherein when the seat unit is in the upright configuration, the backrest and the head support are in the first position and form a substantially plane and continuous surface, and wherein the rotation of the head support is independent of the rotation of the backrest and of the rotation of the leg rest.

4. The passenger seat unit according to claim 1, further comprising a footrest adapted to be separated from the seat surface by a distance corresponding substantially to a dimension of the leg rest, such that when the seat unit is in the bed configuration, the backrest, the seat surface, the leg rest and the footrest form a substantially plane and continuous surface.

5. The passenger seat unit according to claim 1, wherein the seat surface has a dimension in the direction of the joint axis between the backrest and the seat surface, called width, which is greater than the width of the backrest.

6. The passenger seat unit according to claim 1, further comprising a front panel and a shelf adapted to be mounted on the front panel so as to be mobile in rotation around a first axis of rotation between a stowed position in which the shelf is stowed against the front panel and an open position in which the shelf is positioned substantially parallel to the seat surface so as to form a work surface for the passenger.

7. The passenger seat unit according to claim 6, wherein the shelf comprises a first tray, a second tray and a third tray, the trays being superposed, wherein the first tray is adapted to be mounted mobile in rotation around a second axis of rotation perpendicular to the first axis of rotation, and the second tray is adapted to be mounted sliding according to the first axis.

8. The passenger seat unit according to claim 1, further comprising a front panel, the front panel having a recess adapted to install a screen, wherein the screen is adapted to be inclinable relative to the plane formed by the front panel.

9. The passenger seat unit according to claim 1, further comprising a side panel adapted to laterally delimit the seat unit, and further comprising a private door adapted to be mounted on the side panel sliding according to a longitudinal axis of the seat unit.

10. The passenger seat unit according to claim 1, further comprising a shell module comprising a seat surface support adapted to be positioned under the seat surface, and/or side panels adapted to laterally delimit the seat unit, and/or a rear desk adapted to define a footrest of an adjacent rear seat unit, and/or a rear module adapted to define a front panel of an adjacent rear seat unit.

11. The passenger seat unit according to claim 10, wherein the seat surface support and/or the side panels and/or the desk and/or the rear module have a dimension according to the joint axis between the backrest and the seat surface which is adaptable.

12. An arrangement of passenger seat units for an aircraft cabin, comprising a plurality of passenger seat units according to claim 1, the passenger seat units being positioned parallel behind each other, such that the bed surface extends diagonally relative to a longitudinal axis of the seat unit.

13. Arrangement of passenger seat units for an aircraft cabin, comprising a plurality of passenger seat units according to claim 1, the passenger seat units being positioned in staggered formation, such that the bed surface extends parallel to a longitudinal axis of the seat unit.

14. A manufacturing process of a shell module of a passenger seat unit for an aircraft cabin according to claim 10, the process comprising the following steps:
manufacture of a shell module having a maximal shell module width,
determination of a shell module width, the determined shell module width being adapted to be compatible with a width of the aircraft cabin in which the shell module is intended to be arranged, —when the determined shell module width is less than the maximal shell module width, cutting out of the shell module so as to obtain a shell module having a width substantially equal to the determined width.
